(19) United States
(12) Patent Application Publication
(10) Pub. No.: US 2025/0181891 A1
(43) Pub. Date: Jun. 5, 2025

(54) LEVERAGING GRAPH NEURAL NETWORKS, COMMUNITY DETECTION, AND TREE-BASED MODELS FOR TRANSACTION CLASSIFICATIONS

(71) Applicant: PayPal, Inc., San Jose, CA (US)

(72) Inventors: Ori Mendelson, Tel Aviv (IL); Yoav Lotem, Tel Aviv (IL); Irit Friedman-Hauser, Tel Aviv (IL); Roi Spoliansky, Ramat Yishay (IL); Alon Wiener, Tel Aviv (IL)

(21) Appl. No.: 18/524,614

(22) Filed: Nov. 30, 2023

(51) Int. Cl. G06N 3/043

(52) U.S. Cl. CPC G06N 3/043

(57) ABSTRACT

Methods and systems are presented for providing a machine learning model framework that uses multiple models that analyze different aspects of graph data to perform transaction classification. A graph is generated to represent relationships among transactions and fuzzy attributes. The framework includes a graph neural network that generates embeddings for each transaction based on the graph. The framework further includes a machine learning model that generates an initial classification score for a particular transaction based on the embeddings generated for the particular transaction and the actual attributes associated with the particular transaction. One or more communities are identified within the graph based on the connections among various fuzzy attributes. Characteristics associated with a particular community corresponding to the particular transaction are used to modify the initial risk score. A classification is determined for the particular transaction based on the modified risk score.

### BACKGROUND

The present specification generally relates to data classification, and more specifically, to providing a machine learning model framework that leverages multiple graph analysis techniques in classifying data according to various embodiments of the disclosure.

### RELATED ART

Tactics in performing fraudulent transactions electronically are ever-evolving and becoming more sophisticated. Entities that provide services electronically need to keep pace with the fraudulent users in providing security measures, such as accurately detecting fraudulent transactions. These fraudulent transactions can be initiated manually or using scripted attacks. Computer models are often utilized to assist in making a determination of whether a transaction is a fraudulent transaction or not. Many of these computer models are configured to classify transactions based on attributes associated with the transaction (e.g., an Internet Protocol (IP) address used by a device to conduct the transaction, a location associated with the device, an email domain of an email address used in the transaction, a name prefix, etc.). When a pattern of known fraudulent transactions (e.g., fraudulent transactions conducted using the same IP address, or out of the same location, etc.) emerges, the computer models may use the pattern to classify future transactions.

However, fraudulent transaction tactics can be dynamic and may change from time to time. For example, fraudulent users may intelligently use slightly different attributes (e.g., different IP addresses, different locations, etc.) to conduct different fraudulent transactions in order to confuse these computer models, such that patterns cannot be readily or accurately derived from the attributes. As a result, the computer models may not be able to accurately detect at least some of the fraudulent transactions as they do not share identical attributes as other known fraudulent transactions. Thus, there is a need for a more robust computer framework for detecting fraudulent transactions.

### BRIEF DESCRIPTION OF THE FIGURES

FIG. 1 is a block diagram illustrating an electronic transaction system according to an embodiment of the present disclosure;

FIG. 2 is a block diagram illustrating a classification engine according to an embodiment of the present disclosure;

FIG. 3 illustrates an example graph that represents relationships among transactions and fuzzy attributes according to an embodiment of the present disclosure;

FIG. 4 illustrates one or more communities detected within a graph according to an embodiment of the present disclosure;

FIG. 5 illustrates an example dataflow for classifying a transaction according to an embodiment of the present disclosure;

FIG. 6 illustrates an example process for classifying transactions according to an embodiment of the present disclosure;

FIG. 7 illustrates an example neural network that can be used to implement a machine learning model according to an embodiment of the present disclosure; and

FIG. 8 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing a machine learning model framework that uses multiple models that analyze different aspects of graph data to accurately perform data classification. As discussed herein, conventional models that analyze data in a single dimension (e.g., analyzing attributes of the transaction) may not be capable of accurately detecting fraudulent transactions, due to the way that fraudulent users using evolving tactics in conducting fraudulent transactions. For example, fraudulent users may use slightly different attributes (e.g., an IP address of 192.0.1.31 and an IP address of 192.0.1.65, an address of 3001 5^{th} Street and an address of 5034 5^{th} Street, etc.) for conducting different fraudulent transactions (e.g., onboarding transactions, payment transactions, purchase transactions, data access transactions, etc.). Such an approach may confuse a conventional model that strictly analyzes the attributes such that the conventional model may not be able to detect any relationship between the two transactions having the different IP addresses and/or the different physical addresses.

As an effort to counter such tactics, certain models have been designed to analyze fuzzy attributes associated with transactions, instead of actual attributes, to classify the transactions. Fuzzy attributes are attributes that do not have a fixed value. Instead, fuzzy attributes often encompass a range of values (or a set of related values). For example, instead of using an actual attribute of the IP address “192.0.1.31” to represent a transaction, a fuzzy attribute of “192.0.1.X” where ‘X’ can be any number can be used to represent the transaction. In another example, instead of using an actual full address (e.g., “3001 5^{th} Street, New York, NY”), a fuzzy attribute of “a location in the city of New York” may be used to represent the transaction. Using fuzzy attributes, instead of the actual attributes, of transactions to analyze and/or classify different transactions may enable the model to capture relationships and/or patterns among different transactions that would otherwise not be captured by conventional models that use actual attributes to analyze transactions. Thus, the model may determine that the two transactions that have IP addresses of “192.0.1.31” and “192.0.1.65,” respectively, and/or the two transactions having physical addresses of “3001 5^{th} Street” and “5034 5^{th} Street,” respectively, are related to each other since they share the same fuzzy attributes (e.g., the same fuzzy IP address of “192.0.1.X,” the same fuzzy physical address of “XXXX 5^{th} Street,” etc.). If one of the transactions is a known fraudulent transaction, the model may determine that the other transaction is likely a fraudulent transaction as well due to the shared fuzzy attributes. However, a drawback of such a model is that it can be overly inclusive, such that transactions that may not be actually related to each other are grouped together in the same classification based on the shared fuzzy attribute(s). For example, a legitimate transaction that has an associated address of “4013 5^{th} Street”) may be deemed to be related to a fraudulent transaction having an address of “3001 5^{th} Street”) simply because they both have the same fuzzy attribute of “XXXX 5^{th} Street.”

As such, according to various embodiments of the disclosure, a machine learning model framework that uses different models to analyze transactions in multiple dimensions is presented. In some embodiments, the machine learning model framework uses multiple models that analyze both actual attributes and fuzzy attributes of transactions, as well as a community aspect of the transactions, in a graphical manner for classifying data. By analyzing multiple dimensions (or aspects) of transactions, the machine learning model framework may classify transactions more accurately than conventional models that use only one or two dimensions. The machine learning model framework may include a graph generation engine configured to generate a graph that represents connections among transactions and fuzzy attributes. The graph generation engine may obtain transaction data associated with transactions conducted through a service provider from a data storage. The transaction data may include attributes associated with each of the transactions, such as an Internet Protocol (IP) address used by a device to conduct the transaction, a location associated with the device, an email address used in the transaction, a name prefix of a person conducting the transaction, an amount associated with the transaction, a device type of the device used to conduct the transaction, and other attributes. In some embodiments, the graph generation engine may determine fuzzy attributes to represent the actual attributes associated with the transactions.

For example, the graph generation engine may determine an IP C-Class address range (e.g., “192.128.0.X” where “X” can be a value between 0 and 255) to represent the IP address associated with each of the transactions. The graph generation engine may determine multiple fuzzy attributes for each attribute type based on the actual attributes of the transactions. For example, the graph generation engine may determine multiple IP address ranges (e.g., “192.128.0.X,” “192.128.25.X,” “208.36.4.X,” etc.) as fuzzy attributes based on transactions having IP addresses within those ranges. The graph generation engine may also determine multiple physical address ranges (e.g., the city of Brooklyn, the city of Anaheim, the city of Orlando, etc.) as fuzzy attributes based on transactions associated with physical addresses within those cities. The graph generation engine may also determine multiple email address ranges (e.g., the email domain of “gmail.com,” the email domain of “yahoo.com,” the email domain of “msn.com,” etc.) as fuzzy attributes based on transactions associated with physical addresses within those cities. The graph generation engine may continue to determine fuzzy attributes for different attribute types (e.g., names of the person conducting the transactions, transaction amounts, etc.) corresponding to the transactions. The graph generation engine may then associate each transaction with corresponding fuzzy attributes based on the actual attributes of the transaction. For example, a transaction having an associated IP address of “192.128.0.3” and a physical address of “3001 5^{th} Street, Anaheim” may be associated with the fuzzy attributes of “192.128.0.X” and “city of Anaheim.” Multiple transactions that have different actual attributes may be associated with the same fuzzy attribute. For example, another transaction having an IP address of “192.128.0.18” may also be associated with the fuzzy attribute of “192.128.0.X.”

The graph generation engine may generate a transaction vertex in the graph to represent each transaction, and generate an attribute vertex in the graph to represent each fuzzy attribute. In some embodiments, the graph generation engine may also include different features or information associated with each transaction and/or fuzzy attribute in the corresponding vertex. The features or information may be derived from the actual transaction attributes or generated by the graph generation engine based on the generated graph (e.g., a number of connections associated with each vertex, etc.). The graph generation engine may then connect a transaction vertex to an attribute vertex in the graph when the corresponding fuzzy attribute represented by the attribute vertex is associated with the corresponding transaction represented by the transaction vertex. After generating the graph, the machine learning model framework may use multiple machine learning models to analyze different aspects of the graph data in the graph to perform the classification task (e.g., classifying transactions).

In some embodiments, the machine learning model framework may include a graph neural network (GNN) configured to analyze the graph and to generate embeddings for each transaction and/or each fuzzy attribute represented in the graph. For example, the graph generated by the graph generation engine may be provided as input data to the GNN. By traversing and analyzing relationships among different vertices (e.g., edges that connect the different vertices, etc.) in the graph, the GNN may generate embeddings (e.g., vectors in a multi-dimensional space) to represent each vertex in the graph.

In some embodiments, the machine learning model framework may also include a machine learning model (e.g., a gradient boosting tree such as XGBoost, a transformer, etc.) configured to generate an initial classification score (or an initial risk score) for each transaction represented in the graph based on the embeddings generated by the GNN and the actual attributes associated with the transactions. For example, in order to determine a classification score (e.g., a fraud probability, etc.) for a transaction, the machine learning model framework may determine a vertex within the graph that represents the transaction. If none of the vertices in the graph represents the transaction, the graph generation engine may generate a vertex to represent the transaction and insert the vertex into the graph by connect the vertex to other attribute vertices related to the transaction (e.g., the fuzzy attributes that are associated with the transaction, etc.). The GNN may generate embeddings for the vertex based on its relationships with other vertices in the graph. The embeddings may represent how the transaction is related to other transactions based on one or more common fuzzy attributes. The embeddings generated by the GNN and the actual attributes associated with the transaction may be provided as input values to the machine learning model. Based on the embeddings and the actual attributes of the transaction, the machine learning model may be configured and trained to output a classification score representing a likelihood that the transaction should be classified as one or more classifications (e.g., a probability that the transaction is fraudulent, etc.). By combining the embeddings (which represent how the transaction is related to other transactions represented in the graph based on fuzzy attributes) with the actual attributes associated with the transaction as input data for the machine learning model, the machine learning model framework ensures that the machine learning model is neither overly restrictive nor overly inclusive in deriving relationships among various transactions represented by the graph, resulting in a more accurate classification for the transaction.

In some embodiments, in order to further enhance the classification accuracy of the machine learning model framework, the machine learning model framework may also include a community detection engine that is configured to detect communities of transactions within the graph. The community aspect of the transactions may then be used to enhance the accuracy of the classification task. In some embodiments, the community detection engine may also be a machine learning model such as a graph neural network or a clustering model. The machine learning model framework may provide graph data associated with the graph generated by the graph generation engine, and the classification scores generated by the machine learning model for the transaction vertices as input data. In some embodiments, the graph generation engine may modify the graph before providing the graph data to the community detection engine. For example, the graph generation engine may remove the transaction vertices from the graph, leaving only the attribute vertices representing the fuzzy attributes in the graph. After removing the transaction vertices, the graph generation engine may connect two attribute vertices with an edge in the graph when there is at least one transaction that is associated with both fuzzy attributes represented by the two attribute vertices. In some embodiments, the edges connecting the attribute vertices are weighted. For example, the graph generation engine may determine a weight of an edge connecting two attribute vertices based on the number of transactions that are associated with the two fuzzy attributes represented by the two attribute vertices, such that a larger weight is assigned to the edge when a larger number of transactions are associated with the two fuzzy attributes and a smaller weight is assigned to the edge when a smaller number of transactions are associated with the two fuzzy attributes. Such a modified graph enables the community detection engine to determine which fuzzy attributes are related to each other, and how strong the relationships are among the fuzzy attributes.

The community detection engine may partition the modified graph into multiple communities based on the connectedness (connection strength) among the attribute vertices. In some embodiments, the connectedness among the different attribute vertices can be determined based on the weights of the edges that connect the attribute vertices. In some embodiments, the community detection engine may also map the communities from the modified graph to the original graph such that each community may include transactions in addition to fuzzy attributes. The community detection engine may produce community attributes for each of the communities within the graph. In some embodiments, the community attributes may include a restricted account index representing the percentage of accounts that conducted the transactions within the community have been restricted (e.g., suspended or placed on a restricted access level, etc.), a dormant index representing the percentage of accounts that conducted the transactions within the community are dormant (e.g., having activities below a threshold level, etc.), a good index representing the percentage of transactions within the community are non-fraudulent, and a bad index representing the percentage of transactions within the community are fraudulent.

In some embodiments, the machine learning model framework may identify a community to which the transaction belongs, and may use the community attributes associated with the community to modify the score generated by the machine learning model for the transaction. For example, the machine learning model framework may modify the score to lean more toward a fraudulent classification when the restricted index, the dormant index, and/or the bad index exceeds one or more thresholds. The machine learning model framework may also modify the score to lean more toward a non-fraudulent classification when the good index exceeds a threshold. The machine learning model framework may then classify the transaction based on the modified score.

The combination of actual attributes associated with a transaction, embeddings representing relationships between the transaction and other transactions based on fuzzy attributes, and community attributes associated with a community identified for the transaction within the graph enable the machine learning model framework to accurately classify the transaction by reducing the inherent bias associated with the attributes and/or the fuzzy attributes.

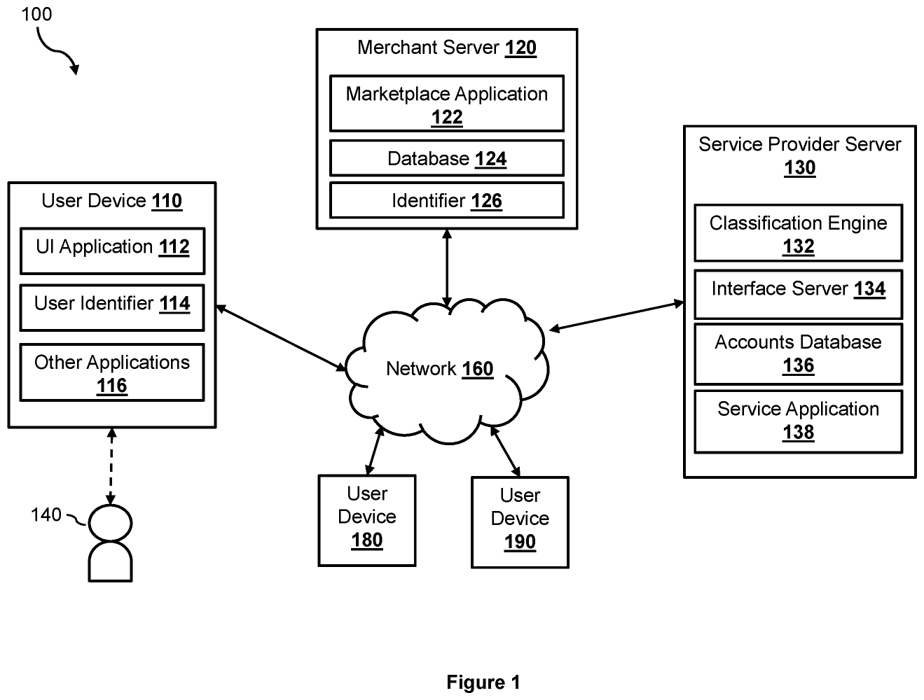

FIG. 1 illustrates an electronic transaction system 100, within which the machine learning model framework may be implemented according to one embodiment of the disclosure. The electronic transaction system 100 includes a service provider server 130 that is associated with the online service provider, a merchant server 120, and user devices 110, 180, and 190 that may be communicatively coupled with each other via a network 160. The network 160 may be implemented as a single network or a combination of multiple networks. For example, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110 may be utilized by a user 140 to interact with the merchant server 120 and/or the service provider server 130 over the network 160. For example, the user 140 may use the user device 110 to conduct an online transaction with the merchant server 120 via websites hosted by, or mobile applications associated with, the merchant server 120. The user 140 may also log in to a user account to access account services or conduct electronic transactions (e.g., data access, account transfers or payments, onboarding transactions, etc.) with the service provider server 130. The user device 110 may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one example, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110 may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110 may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., a particular profile).

Each of the user devices 180 and 190 may include similar hardware and software components as the user device 110, such that each of the user devices 180 and 190 may be operated by a corresponding user to interact with the merchant server 120 and/or the service provider server 130 in a similar manner as the user device 110.

The merchant server 120 may be maintained by a business entity (or in some cases, by a partner of a business entity that processes transactions on behalf of business entity). Examples of business entities include merchants, resource information providers, utility providers, online retailers, real estate management providers, social networking platforms, a cryptocurrency brokerage platform, etc., which offer various items for purchase and process payments for the purchases. The merchant server 120 may include a merchant database 124 for identifying available items or services, which may be made available to the user device 110 for viewing and purchase by the respective users.

The merchant server 120 may include a marketplace application 122, which may be configured to provide information over the network 160 to the user interface application 112 of the user device 110. The marketplace application 122 may include a web server that hosts a merchant website for the merchant. For example, the user 140 of the user device 110 may interact with the marketplace application 122 through the user interface application 112 over the network 160 to search and view various items or services available for purchase in the merchant database 124. The merchant server 120 may include at least one merchant identifier 126, which may be included as part of the one or more items or services made available for purchase so that, e.g., particular items and/or transactions are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user devices 110, 180, and 190, and the service provider server 130 via the network 160.

The service provider server 130 may be maintained by a transaction processing entity or an online service provider, which may provide processing of electronic transactions between users (e.g., the user 140 and users of other user devices, etc.) and/or between users and one or more merchants. As such, the service provider server 130 may include a service application 138, which may be adapted to interact with the user device 110 and/or the merchant server 120 over the network 160 to facilitate the electronic transactions (e.g., electronic payment transactions, data access transactions, etc.) among users and merchants processed by the service provider server 130. In one example, the service provider server 130 may be provided by PayPal®, Inc., of San Jose, California, USA, and/or one or more service entities or a respective intermediary that may provide multiple point of sale devices at various locations to facilitate transaction routings between merchants and, for example, service entities.

The service application 138 may include a payment processing application (not shown) for processing purchases and/or payments for electronic transactions between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user (e.g., the user 140, or a merchant associated with the merchant server 120, etc.) may access a user account associated with the user and access various services offered by the service provider server 130, by generating HTTP requests directed at the service provider server 130.

The service provider server 130 may be configured to maintain one or more user accounts and merchant accounts in an accounts database 136, each of which may be associated with a profile and may include account information associated with one or more individual users (e.g., the user 140 associated with user device 110, users of the user devices 180 and 190, etc.) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. Account information may also include user purchase profile information such as account funding options and payment options associated with the user, payment information, receipts, and other information collected in response to completed funding and/or payment transactions.

In one implementation, a user may have identity attributes stored with (such as accounts database 136) or accessible by the service provider server 130, and the user may have credentials to authenticate or verify identity with the service provider server 130. User attributes may include personal information, including photos, date of birth, social security number, home address, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

When a user (e.g., the user 140) conducts a transaction with the merchant server 120 and/or the service provider server 130, the service provider server 130 may obtain attributes associated with the transaction. The attributes may be obtained from the user device 110 (e.g., a location of the device, an Internet Protocol (IP) address associated with the device, a device identifier, a browser type used by the device to conduct the transaction, a operating system type running on the device, etc.). The attributes may also be obtained from the user 140 via the user device 110 (e.g., the user providing a transaction amount of the transaction, the user providing user information of the user, etc.). For each transaction conducted via the service provider server 130, the service provider server 130 may store transaction data (which may include the attributes associated with the transaction) for future usage, for example, in the accounts database 136.

In various embodiments, the service provider server 130 also includes a classification engine 132 that implements the machine learning model framework as discussed herein. In some embodiments, the classification engine 132 may be configured to classify transactions conducted by various users (e.g., the user 140, the users of the user devices 180 and 190, etc.) with the merchant server 120 and/or the service provider server 130 using the techniques and the machine learning model framework disclosed herein. The transactions may include different types of transactions such as onboarding transactions (e.g., signing up for a new account), purchase transactions, payment transactions, credit application transactions, data access transactions, etc. Based on the classification determined for a transaction, the classification engine 132 and/or the service application 138 may perform one or more actions associated with the transaction and/or the account that initiated the transaction. For example, the classification engine 132 and/or the service application 138 may deny the processing of the transaction, request additional data from a user, such as authentication data, and/or restricting the account (e.g., suspend the account, reduce the access level of one or more functionalities for the account, etc.).

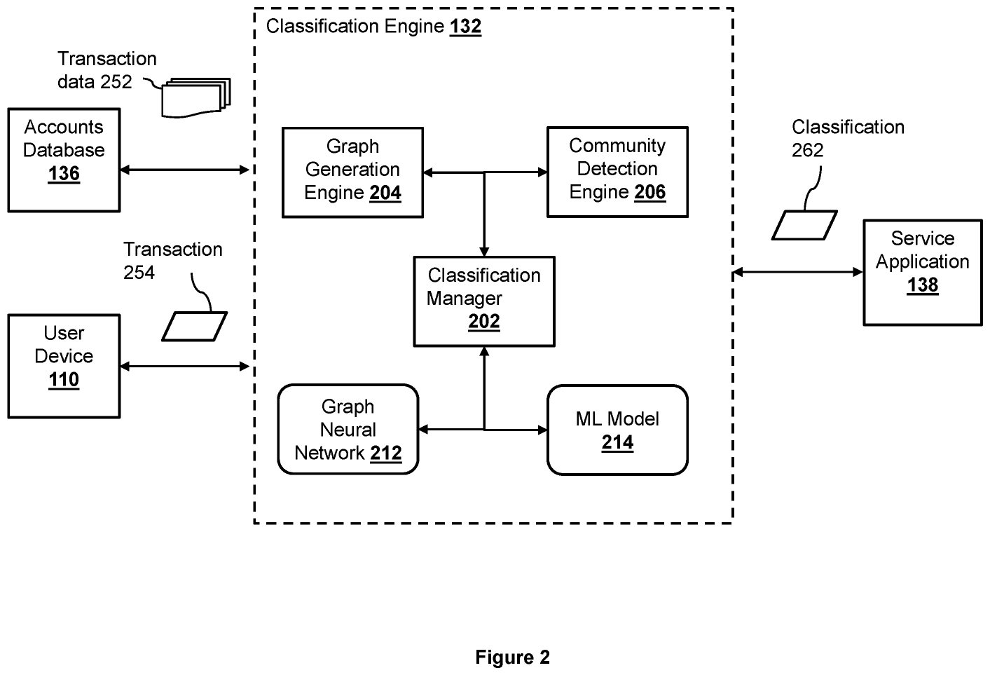

FIG. 2 is a block diagram illustrating the classification engine 132 according to various embodiments of the disclosure. As shown, the classification engine 132 includes a classification manager 202, a graph generation engine 204, a community detection engine 206, a graph neural network (GNN) 212, and a machine learning (ML) model 214. In some embodiments, the classification manager 202 may retrieve transaction data from a data storage, such as the accounts database 136. The transaction data may include attributes associated with each of the transactions conducted by the users of the service provider server 130 (e.g., the user 140, the users of the user devices 180 and 190, etc.) and stored in the accounts database 136. The attributes may include an Internet Protocol (IP) address used by a device (e.g., the user device 110, the user device 180, the user device 190, etc.) to conduct the transaction, a location associated with the device, an email address used in the transaction, a name prefix of a person conducting the transaction, an amount associated with the transaction, a device type of the device used to conduct the transaction, and other attributes.

In some embodiments, the graph generation engine 204 may generate a graph that represents relationships among various transactions and fuzzy attributes based on the attribute data retrieved from the accounts database 136. To generate the graph, the graph generation engine 204 may first determine fuzzy attributes to represent the actual attributes associated with the transactions. For example, when a transaction is associated with an IP address of “192.128.0.35,” the graph generation engine 204 may generate an IP C-Class address range of “192.128.0.X” as a fuzzy attribute to represent the transaction, where “X” can be a value between 0 and 255. In another example, when a transaction is associated with a physical address of “3001 5^{th} Street, Anaheim, CA,” the graph generation engine 204 may generate a geographical area (such as a city, e.g., “City of Anaheim”) as a fuzzy attribute to represent the transaction. By expanding the attribute coverage of each attribute, transactions that have similar attributes, but may not have identical attributes, can still be determined to be related to one another based on the common fuzzy attribute associated with the transactions.

The graph generation engine 204 may generate a graph based on the transactions and the fuzzy attributes. For example, the graph generation engine 204 may generate a transaction vertex in the graph to represent each transaction, and generate an attribute vertex in the graph to represent each fuzzy attribute. The graph generation engine 204 may then connect a transaction vertex to an attribute vertex in the graph when the corresponding fuzzy attribute represented by the attribute vertex is associated with the corresponding transaction represented by the transaction vertex. For example, a transaction vertex representing the transaction having an associated IP address of “192.128.0.35” may be connected to an attribute vertex representing the fuzzy attribute of an IP address range “192.128.0.X.” Similarly, a transaction vertex representing another transaction having an associated IP address of “192.128.0.3” may also be connected to the attribute vertex representing the fuzzy attribute of an IP address range “192.128.0.X.”

After generating the graph, the classification manager 202 may use the GNN 212 to analyze the graph and to generate embeddings for each vertex in the graph. For example, the classification manager 202 may provide the graph generated by the graph generation engine 204 as input data to the GNN 212. By traversing and analyzing relationships among different vertices (e.g., edges that connect the different vertices, etc.) in the graph, the GNN 212 may generate embeddings (e.g., vectors in a multi-dimensional space) to represent each vertex in the graph. The classification manager 202 may associate the embeddings generated for each vertex with a corresponding transaction or a corresponding fuzzy attribute represented by the vertex.

The classification engine 132 may be requested (e.g., by the service application 138 or other modules in the service provider server 130) to classify one or more accounts and/or one or more transactions. For example, when the service provider server 130 receives a request to process a transaction (e.g., an onboarding transaction, a purchase transaction, a payment transaction, a data access transaction, etc.), the service provider server 130 may request the classification engine 132 to determine a classification (or a classification score) for the transaction, which indicates whether the transaction is a fraudulent transaction or not. In some embodiments, the classification manager 202 may use the ML model 214 to generate an initial classification score for the transaction based on the embeddings generated by the GNN 212 and the attributes of the transaction. The classification manager 202 may first determine whether a vertex in the graph has already been generated to represent the transaction. If no vertices in the graph represents the transaction, the classification manager 202 may retrieve attributes associated with the transaction (e.g., from the device that initiates the transaction or the service provider server 130), and may use the graph generation engine 204 to generate a transaction vertex to represent the transaction in the graph. The graph generation engine 204 may generate the transaction vertex for the transaction. The graph generation engine 204 may also determine one or more fuzzy attributes that are associated with the transaction based on the actual attributes of the transaction, and may connect the transaction vertex to one or more attribute vertices in the graph representing the one or more fuzzy attributes.

The classification manager 202 may then use the GNN 212 to generate embeddings for the vertex that represents the transaction. The embeddings may represent the relationships of the transaction with other transactions represented in the graph based on fuzzy attributes that are shared among the transaction and the other transactions and other information based on the connections formed in the graph. The classification manager 202 may provide the embeddings generated by the GNN 212 for the transaction and the actual attributes of the transaction as input values to the ML model 214. Based on the embeddings and the actual attributes, the ML model may be configured and trained to output a classification score for the transaction. For example, the classification score may represent a probability that the transaction corresponds to a fraudulent transaction.

In some embodiments, in order to further enhance the accuracy of classifying the transaction, the classification manager 202 may use the community detection engine 206 to analyze the community aspect of the transactions and modify the initial classification score based on the community aspect of the transactions. In some embodiments, the community detection engine 206 may also be a machine learning model such as a graph neural network, a clustering model, etc., or a computer module that uses one or more graph algorithms (e.g., the Louvain algorithm, etc.) to identify communities within a graph. The classification manager 202 may provide graph data associated with the graph generated by the graph generation engine 204, and the classification score generated by the ML model 214 for the transaction as input data for the community detection engine 206. In some embodiments, the graph generation engine 204 may modify the graph before providing the graph data to the community detection engine 206. For example, the graph generation engine 204 may remove the transaction vertices from the graph, leaving only the attribute vertices representing the fuzzy attributes in the graph. After removing the transaction vertices, the graph generation engine 204 may connect two attribute vertices with an edge in the graph when there is at least one transaction that is associated with both fuzzy attributes represented by the two attribute vertices. In some embodiments, the edges connecting the attribute vertices are weighted. For example, the graph generation engine 204 may determine a weight of an edge connecting two attribute vertices based on the number of transactions that are associated with the two fuzzy attributes represented by the two attribute vertices, such that a larger weight is assigned to the edge when a larger number of transactions are associated with the two fuzzy attributes and a smaller weight is assigned to the edge when a smaller number of transactions are associated with the two fuzzy attributes. Such a modified graph enables the community detection engine 206 to determine which fuzzy attributes are related to each other, and how strong are the relationships among the fuzzy attributes.

The community detection engine 206 may partition the modified graph into multiple communities based on the connectedness (connection strength) among the attribute vertices. In some embodiments, the connectedness among the different attribute vertices can be determined based on the weights of the edges that connect the attribute vertices. In some embodiments, the community detection engine 206 may also map the communities from the modified graph to the original graph such that each community may include transactions in addition to fuzzy attributes. The community detection engine 206 may produce community attributes for each of the communities within the graph. In some embodiments, the community attributes may include a restricted account index representing the percentage of accounts that conducted the transactions within the community have been restricted (e.g., suspended or placed on a restricted access level, etc.), a dormant index representing the percentage of accounts that conducted the transactions within the community are dormant (e.g., having activities below a threshold level, etc.), a good index representing the percentage of transactions within the community are non-fraudulent, and a bad index representing the percentage of transactions within the community are fraudulent.

In some embodiments, the classification manager 202 and/or the community detection engine 206 may identify a community to which the transaction belongs, and may use the community attributes associated with the community to modify the classification score generated by the ML model 214 for the transaction. For example, the classification manager 202 and/or the community detection engine 206 may modify the classification score to lean more toward a fraudulent classification when the restricted index, the dormant index, and/or the bad index exceeds one or more thresholds. The classification manager 202 and/or the community detection engine 206 may also modify the score to lean more toward a non-fraudulent classification when the good index exceeds a threshold. The classification manager 202 may then classify the transaction based on the modified score. For example, the classification manager 202 may classify the transaction as a fraudulent transaction when the classification score is above a predetermined threshold, or classify the transaction as a non-fraudulent transaction when the classification score is below the threshold. After determining a classification 262 for the transaction, the classification engine 132 may provide the classification 262 to the service application 138, such that the service application 138 may perform one or more actions associated with the transaction and/or the account through which the transaction was initiated based on the classification 262. For example, the service application 138 may deny the request for processing the transaction. In another example, the service application 138 may modify an access level of an account through which the transaction was initiated, for example, impose restrictions on the account, suspend the account, etc. In another example, the service application 138 may request further or additional authentication from a user requesting or initiating the transaction.

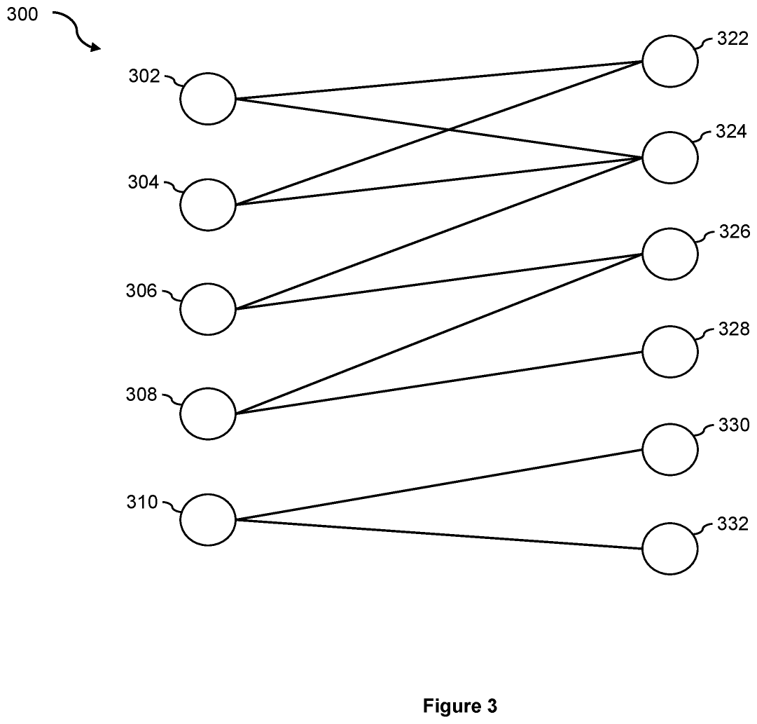

FIG. 3 illustrates a graph 300 that represents transactions and fuzzy attributes according to various embodiments of the disclosure. In some embodiments, the graph 300 may be generated by the graph generation engine 204 to represent relationships among various transactions and fuzzy attributes. As shown, the graph 300 includes transaction vertices 302, 304, 306, 308, and 310 representing five different transactions, respectively. These transactions represented by the transaction vertices 302, 304, 306, 308, and 310 may be conducted by the same user or different users. The graph 300 also includes attribute vertices 322, 324, 326, 328, 330, and 332. Each of the attribute vertices 322, 324, 326, 328, 330, and 332 may represent a corresponding fuzzy attribute. For example, the attribute vertex 322 may represent an IP address range of “192.30.5.X,” and the attribute vertex 326 may represent another IP address range of “192.35.10.X”. The attribute vertex 324 may represent a geographical area such as “the City of Anaheim” and the attribute vertex 328 may represent another geographical area such as “the City of New York.” The graph generation engine 204 may connect transaction vertices to different attribute vertices based on their associations. For example, the transaction vertex 302 is connected to the attribute vertices 322 and 324 based on the transaction represented by the vertex 302 is associated with the fuzzy attributes represented by the attribute vertices 322 and 324 (e.g., the transaction is associated with an IP address of “192.30.5.13” and a physical address of “312 Main Street, Anaheim”).

In this example, the transaction vertex 304 is also connected to the attribute vertices 322 and 324. While the transaction vertex 304 and the transaction vertex 302 are connected to the same attribute vertices 322 and 324, the transactions represented by the transaction vertex 304 and the transaction vertex 302 may not have identical attributes, but may have attributes that are sufficiently similar such that they are grouped into the same fuzzy attributes represented by the attribute vertices 322 and 324. This way, even when fraudulent users change the attributes slightly when conducting different fraudulent transactions, the graph 300 may still represent the connections between the transactions. The graph 300 also shows that the transaction vertex 306 is connected to the attribute vertices 324 and 326, that the transaction vertex 308 is connected to the attribute vertices 326 and 328, and that the transaction vertex 310 is connected to the attribute vertices 330 and 332.

The graph 300 may be provided to the GNN 212. The GNN 212 may be configured to generate embeddings for each of the vertices in the graph 300. In some embodiments, the GNN 212 may generate embeddings based on the relationship among the vertices in the graph 300. For example, the embeddings generated for the vertex 302 may indicate its relationship with the vertex 304 based on their connections to the same attribute vertices 322 and 324. The embeddings generated for the vertex 306 may also indicate its relationships with vertices 304 and 308 based on their connections to one or more common attribute vertices. On the other hand, the embeddings generated for the vertex 310 may indicate the lack of relationships with other transaction vertices based on its connected attribute vertices having no connections with any other transaction vertices. The embeddings may be provided to the ML model 214 to generate a classification score for a transaction represented by a corresponding transaction vertex in the graph 300.

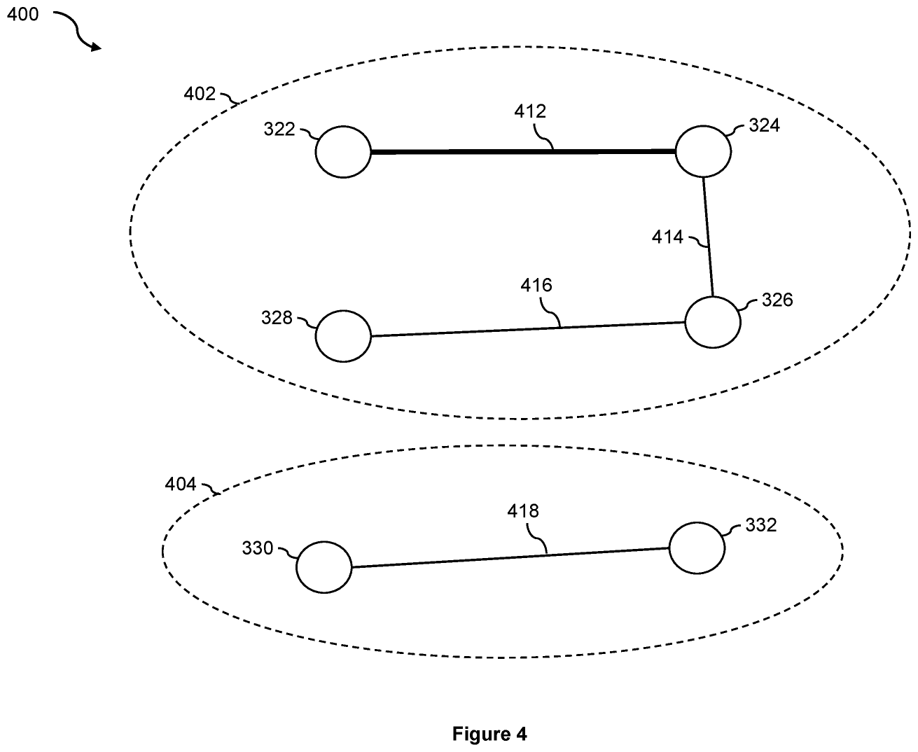

FIG. 4 illustrates a modified graph 400 and communities within the modified graph 400 according to various embodiments of the disclosure. In some embodiments, the modified graph 400 may be generated by the graph generation engine 204 modifying the graph 300. To modify the graph 300, the graph generation engine 204 may first remove all of the transaction vertices (such as the transaction vertices 302, 304, 306, 308, and 310) from the graph 300. The graph generation engine 204 may then generate new connections to connect the attribute vertices 322, 324, 326, 328, 330, and 332 in the modified graph 400 based on the connections in the original graph 300. For example, the graph generation engine 204 may connect the attribute vertex 322 with the attribute vertex 324 via an edge 412 since the attribute vertices 322 and 324 are both connected to transaction vertices 302 and 304 in the graph 300. The graph generation engine 204 may also connect the attribute vertices 324 and 326 via an edge 414 since the attribute vertices 324 and 326 are both connected to the transaction vertex 306 in the graph 300. The graph generation engine 204 may also connect the attribute vertices 326 and 328 via an edge 416 since the attribute vertices 326 and 328 are both connected to the transaction vertex 308 in the graph 300. The graph generation engine 204 may also connect the attribute vertices 330 and 332 via an edge 418 since the attribute vertices 330 and 332 are both connected to the transaction vertex 310 in the graph 300.

In some embodiments, the graph generation engine 204 may also assign weights to the edges 412, 414, 416, and 418, such that a larger weight is assigned to the edge when a larger number of transactions are associated with the two fuzzy attributes and a smaller weight is assigned to the edge when a smaller number of transactions are associated with the two fuzzy attributes. For example, the graph generation engine 204 may assign a weight of “2” to the edge 412 that connects the attribute vertices 322 and 324 based on the two transaction vertices 302 and 304 that are connected to the attribute vertices 322 and 324 in the graph 300. The graph generation engine 204 may assign a weight of “1” to each of the edges 414, 416, and 418, since only one transaction vertex is connected to the respective pairs of attribute vertices in the graph 300. Such a modified graph enables the community detection engine 206 to determine which fuzzy attributes are related to each other, and how strong are the relationships among the fuzzy attributes. For example, when edges within a community have larger weights, the community detection engine 206 may determine that the relationships among the fuzzy attributes are stronger than edges within a community having smaller weights. The community detection engine 206 may partition the modified graph 400 into multiple communities based on the connections among the attribute vertices. For example, the community detection engine 206 may group the attribute vertices 322, 324, 328, and 326 into a community 402 based on the attribute vertices 322, 324, 326, and 328 being connected with each other, directly or indirectly. The community detection engine 206 may also group the attribute vertices 330 and 332 into another community 404. The community detection engine 206 separates the two communities 402 and 404 because there is no connection between the vertices in the community 402 and the vertices in the community 404.

In some embodiments, the community detection engine 206 may map the partitions of communities in the modified graph 400 to the graph 300. Thus, the community detection engine 206 may determine that the transaction vertices 302, 304, 306, and 308, along with the attribute vertices 322, 324, 326, and 328, belong to the same community 402, and that the transaction vertex 310, along with the attribute vertices 330 and 332, belong to the other community 404. The community detection engine 206 may also derive community attributes for each of the communities 402 and 404, which enables the classification manager 202 to modify the initial classification score(s) generated by the ML model 214.

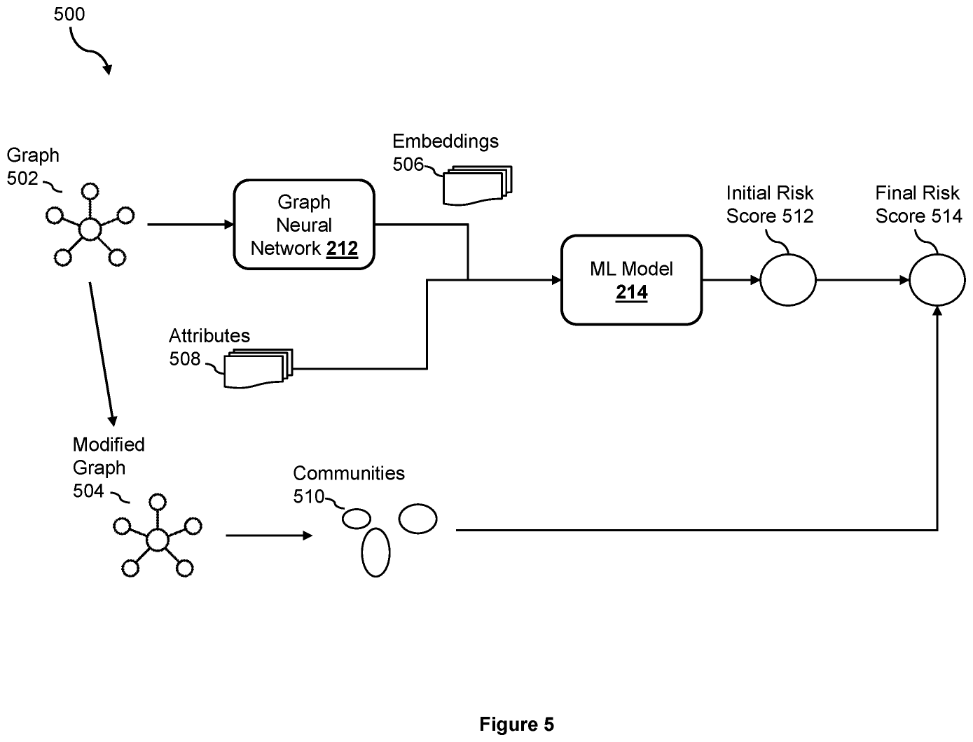

FIG. 5 illustrates an example data flow 500 for classifying a transaction using the machine learning model framework according to various embodiments of the disclosure. The data flow 500 begins with the graph generation engine 204 generating a graph 502 to represent transactions and their relationships with various fuzzy attributes. The graph 502 may correspond to the graph 300 in FIG. 3. The GNN 212 may generate embeddings 506 for each vertex in the graph 502. The embeddings 506 and the actual attributes 508 of a transaction may be provided to the ML model 214 to generate an initial risk score 512. The initial risk score 512 may indicate a probability that the transaction is fraudulent. In some embodiments, the graph generation engine 204 may also modify the graph 502 to generate a modified graph 504. The modified graph 504 may correspond to the modified graph 400 in FIG. 4. The modified graph 504 may be provided to the community detection engine 206 to identify various communities 510 within the graph 502. Data associated with the communities 510 may be used to modify the initial risk score 512 to generate the final risk score 514. The classification manager 202 may then determine a classification of the transaction based on the final risk score 514. The classification may be used by the service application 138 to perform one or more actions associated with the transaction and/or an account.

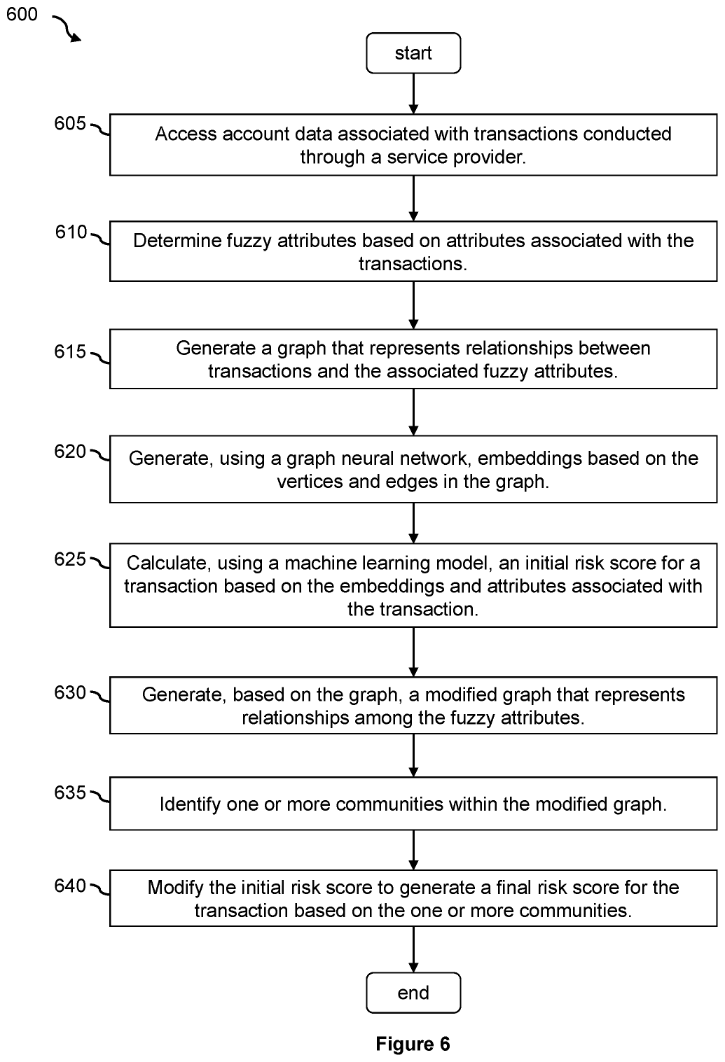

FIG. 6 illustrates a process 600 for performing a data classification process using the machine learning model framework according to various embodiments of the disclosure. In some embodiments, at least a portion of the process 600 may be performed by the classification engine 132. The process 600 begins by accessing (at step 605) account data associated with transactions conducted through a service provider. For example, the classification manager 202 may retrieve data associated with transactions conducted through various accounts of the service provider server 130 from the accounts database 136. In some embodiments, the classification manager 202 may be configured to retrieve data associated with transactions conducted within a period of time (e.g., the past 3 months, etc.). The data may include attributes associated with the different transactions.

The process 600 determines (at step 610) fuzzy attributes based on attributes associated with the transactions. For example, the graph generation engine 204 may determine various fuzzy attributes to represent actual attributes of the transactions recorded in the accounts database. For example, the graph generation engine 204 may determine a range of values that encompass the actual attribute of a transaction, such that different attributes from different transactions may be associated with the same fuzzy attribute.

The process 600 then generates (at step 615) a graph that represents relationships between transactions and the associated fuzzy attributes and generates (at step 620), using a graph neural network, embeddings based on the vertices and edges in the graph. For example, the graph generation engine 204 may generate a graph based on the transactions and the fuzzy attributes. The graph generation engine 204 may generate a transaction vertex for each transaction, and an attribute vertex for each fuzzy attribute. The graph generation engine 204 may then connect each transaction vertex to one or more attribute vertices when the corresponding transaction represented by the transaction vertex is associated with the fuzzy attributes represented by the one or more attribute vertices. The graph is then provided to the GNN 212. The GNN 212 may generate embeddings for each vertex based on the relationships among the transaction vertices and the attribute vertices in the graph.

The process 600 calculates (at step 625), using a machine learning model, an initial risk score for a transaction based on the embeddings and the attributes associated with the transaction. For example, the embeddings associated with a particular transaction and the actual attributes of the particular transaction may be provided to the ML model 214. The ML model 214 may generate a score indicating a classification of the particular transaction based on the embeddings and the actual attributes.

The process 600 then generates (at step 630), based on the graph, a modified graph that represents relationships among the fuzzy attributes. For example, the graph generation engine 204 may modify the graph 300 to generate the modified graph 400. Specifically, the graph generation engine 204 may remove all of the transaction vertices from the graph 300. The graph generation engine 204 may then connect attribute vertices when one or more transactions are associated with the fuzzy attributes associated with the attribute vertices.

The process 600 identifies (at step 635) one or more communities within the modified graph and modifies (at step 640) the initial risk score to generate a final risk score for the transaction based on the one or more communities. For example, the modified graph 400 may be provided to the community detection engine 206. The community detection engine 206 may partition the graph 400 into two or more communities based on the connections within the modified graph 400. The community detection engine 206 may then map the partitions back to the original graph 300, such that each partition may include both the transactions and the fuzzy attributes corresponding to the community. The classification manager 202 may then identify a particular community that includes the vertex that represents the particular transaction. The classification manager 202 may determine attributes associated with the particular community and may modify the initial risk score based on the community attributes.

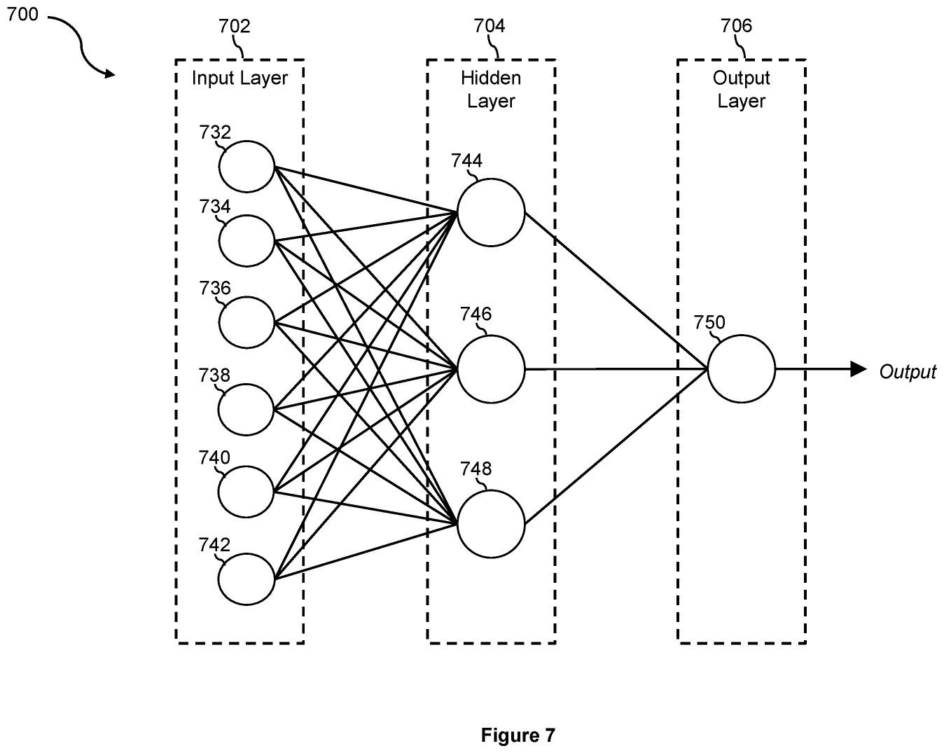

FIG. 7 illustrates an example artificial neural network 700 that may be used to implement a machine learning model, such as the GNN 212, the ML model 214, and/or the community detection engine 206. As shown, the artificial neural network 700 includes three layers—an input layer 702, a hidden layer 704, and an output layer 706. Each of the layers 702, 704, and 706 may include one or more nodes (also referred to as “neurons”). For example, the input layer 702 includes nodes 732, 734, 736, 738, 740, and 742, the hidden layer 704 includes nodes 744, 746, and 748, and the output layer 706 includes a node 750. In this example, each node in a layer is connected to every node in an adjacent layer via edges and an adjustable weight is often associated with each edge. For example, the node 732 in the input layer 702 is connected to all of the nodes 744, 746, and 748 in the hidden layer 704. Similarly, the node 744 in the hidden layer is connected to all of the nodes 732, 734, 736, 738, 740, and 742 in the input layer 702 and the node 750 in the output layer 706. While each node in each layer in this example is fully connected to the nodes in the adjacent layer(s) for illustrative purpose only, it has been contemplated that the nodes in different layers can be connected according to any other neural network topologies as needed for the purpose of performing a corresponding task.

The hidden layer 704 is an intermediate layer between the input layer 702 and the output layer 706 of the artificial neural network 700. Although only one hidden layer is shown for the artificial neural network 700 for illustrative purpose only, it has been contemplated that the artificial neural network 700 used to implement any one of the computer-based models may include as many hidden layers as necessary. The hidden layer 704 is configured to extract and transform the input data received from the input layer 702 through a series of weighted computations and activation functions.

In this example, the artificial neural network 700 receives a set of inputs and produces an output. Each node in the input layer 702 may correspond to a distinct input. For example, when the artificial neural network 700 is used to implement the GNN 212, the nodes in the input layer 702 may correspond to different attributes of a graph (e.g., different attributes of each vertex, such as information about the vertex and other vertices that are connected to the vertex, etc.). When the artificial neural network 700 is used to implement the ML model 214, the nodes in the input layer 702 may correspond to different embeddings and different attributes of a transaction. When the artificial neural network 700 is used to implement the community detection engine 206, the nodes in the input layer 702 may correspond to different attributes of a modified graph (e.g., different attributes of each attribute vertex, such as information about the attribute vertex and other attribute vertices that are connected to the attribute vertex, etc.).

In some examples, each of the nodes 744, 746, and 748 in the hidden layer 704 generates a representation, which may include a mathematical computation (or algorithm) that produces a value based on the input values received from the nodes 732, 734, 736, 738, 740, and 742. The mathematical computation may include assigning different weights (e.g., node weights, edge weights, etc.) to each of the data values received from the nodes 732, 734, 736, 738, 740, and 742, performing a weighted sum of the inputs according to the weights assigned to each connection (e.g., each edge), and then applying an activation function associated with the respective node (or neuron) to the result. The nodes 744, 746, and 748 may include different algorithms (e.g., different activation functions) and/or different weights assigned to the data variables from the nodes 732, 734, 736, 738, 740, and 742 such that each of the nodes 744, 746, and 748 may produce a different value based on the same input values received from the nodes 732, 734, 736, 738, 740, and 742. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 702 is transformed into rather different values indicative data characteristics corresponding to a task that the artificial neural network 700 has been designed to perform.

In some examples, the weights that are initially assigned to the input values for each of the nodes 744, 746, and 748 may be randomly generated (e.g., using a computer randomizer). The values generated by the nodes 744, 746, and 748 may be used by the node 750 in the output layer 706 to produce an output value (e.g., a response to a user query, embeddings, a classification prediction, etc.) for the artificial neural network 700. The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class. When the artificial neural network 700 is used to implement the ML model 214, the output node 750 may be configured to generate a binary classification (or a classification score). When the artificial neural network 700 is used to implement the GNN 212, the output node 750 may be configured to generate embeddings for various nodes within a graph. When the artificial neural network 700 is used to implement the community detection engine 206, the output node 750 may be configured to determine partitions (e.g., communities) within a graph.

In some examples, the artificial neural network 700 may be implemented on one or more hardware processors, such as CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware used to implement the neural network structure is specifically configured based on factors such as the complexity of the neural network, the scale of the tasks (e.g., training time, input data scale, size of training dataset, etc.), and the desired performance.

The artificial neural network 700 may be trained by using training data based on one or more loss functions and one or more hyperparameters. By using the training data to iteratively train the artificial neural network 700 through a feedback mechanism (e.g., comparing an output from the artificial neural network 700 against an expected output, which is also known as the “ground-truth” or “label”), the parameters (e.g., the weights, bias parameters, coefficients in the activation functions, etc.) of the artificial neural network 700 may be adjusted to achieve an objective according to the one or more loss functions and based on the one or more hyperparameters such that an optimal output is produced in the output layer 706 to minimize the loss in the loss functions. Given the loss, the negative gradient of the loss function is computed with respect to each weight of each layer individually. Such negative gradient is computed one layer at a time, iteratively backward from the last layer (e.g., the output layer 706 to the input layer 702 of the artificial neural network 700). These gradients quantify the sensitivity of the network's output to changes in the parameters. The chain rule of calculus is applied to efficiently calculate these gradients by propagating the gradients backward from the output layer 706 to the input layer 702.

Parameters of the artificial neural network 700 are updated backwardly from the last layer to the input layer (backpropagating) based on the computed negative gradient using an optimization algorithm to minimize the loss. The backpropagation from the last layer (e.g., the output layer 706) to the input layer 702 may be conducted for a number of training samples in a number of iterative training epochs. In this way, parameters of the artificial neural network 700 may be gradually updated in a direction to result in a lesser or minimized loss, indicating the artificial neural network 700 has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as to classify a transaction, etc. For example, when the artificial neural network 700 is used to implement the ML model 214, the training data may include transaction data corresponding to transactions that have been previously processed, and labels indicating classifications of the transactions (e.g., whether the transactions are fraudulent or not, etc.).

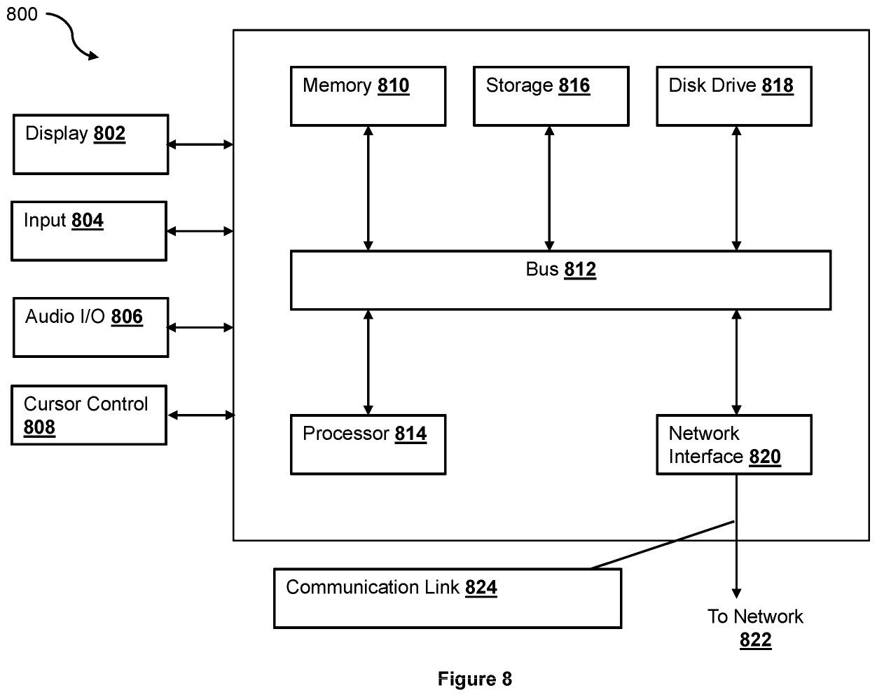

FIG. 8 is a block diagram of a computer system 800 suitable for implementing one or more embodiments of the present disclosure, including the service provider server 130, the merchant server 120, and the user devices 110, 180, and 190. In various implementations, each of the user devices 110, 180, and 190 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, 130, 180, and 190 may be implemented as the computer system 800 in a manner as follows.

The computer system 800 includes a bus 812 or other communication mechanism for communicating information data, signals, and information between various components of the computer system 800. The components include an input/output (I/O) component 804 that processes a user (i.e., sender, recipient, service provider) action, such as selecting keys from a keypad/keyboard, selecting one or more buttons or links, etc., and sends a corresponding signal to the bus 812. The I/O component 804 may also include an output component, such as a display 802 and a cursor control 808 (such as a keyboard, keypad, mouse, etc.). The display 802 may be configured to present a login page for logging into a user account or a checkout page for purchasing an item from a merchant. An optional audio input/output component 806 may also be included to allow a user to use voice for inputting information by converting audio signals. The audio I/O component 806 may allow the user to hear audio. A transceiver or network interface 820 transmits and receives signals between the computer system 800 and other devices, such as another user device, a merchant server, or a service provider server via a network 822. In one embodiment, the transmission is wireless, although other transmission mediums and methods may also be suitable. A processor 814, which can be a micro-controller, digital signal processor (DSP), or other processing component, processes these various signals, such as for display on the computer system 800 or transmission to other devices via a communication link 824. The processor 814 may also control transmission of information, such as cookies or IP addresses, to other devices.

The components of the computer system 800 also include a system memory component 810 (e.g., RAM), a static storage component 816 (e.g., ROM), and/or a disk drive 818 (e.g., a solid-state drive, a hard drive). The computer system 800 performs specific operations by the processor 814 and other components by executing one or more sequences of instructions contained in the system memory component 810. For example, the processor 814 can perform the transaction classification functionalities described herein, for example, according to the process 600.

Logic may be encoded in a computer readable medium, which may refer to any medium that participates in providing instructions to the processor 814 for execution. Such a medium may take many forms, including but not limited to, non-volatile media, volatile media, and transmission media. In various implementations, non-volatile media includes optical or magnetic disks, volatile media includes dynamic memory, such as the system memory component 810, and transmission media includes coaxial cables, copper wire, and fiber optics, including wires that comprise the bus 812. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 800. In various other embodiments of the present disclosure, a plurality of computer systems 800 coupled by the communication link 824 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
accessing account data associated with a plurality of accounts, wherein each account in the plurality of accounts is associated with one or more fuzzy attributes from a set of fuzzy attributes;
generating a graph based on the account data, wherein the graph represents relationships among the plurality of accounts and the set of fuzzy attributes;
identifying one or more communities of fuzzy attributes from the set of fuzzy attributes based on the graph;
generating, using a graph neural network, embeddings associated with the particular account based on the graph;
determining a risk score for the particular account based on the embeddings and the one or more communities of fuzzy attributes; and
performing an action associated with the particular account based on the risk score.

2. The system of claim 1, wherein the operations further comprise:
determining, using a machine learning model, an initial risk score associated with the particular account based on the embeddings, wherein the risk score is determined further based on the initial risk score.

3. The system of claim 2, wherein each account in the plurality of accounts is associated with a corresponding set of attributes, and wherein the determining the initial risk score associated with the particular account is further based on the corresponding set of attributes associated with the particular account.

4. The system of claim 2, wherein the determining the risk score comprises modifying the initial risk score based on characteristics associated with at least one of the one or more communities.

5. The system of claim 1, wherein the plurality of accounts is associated with a set of attributes, and wherein the operations further comprise:
deriving the set of fuzzy attributes from the set of attributes based on the account data, wherein each fuzzy attribute in the set of fuzzy attributes represents an abstraction of a corresponding attribute in the set of attributes.

6. The system of claim 1, wherein the graph comprises a first set of vertices representing the plurality of accounts, a second set of vertices representing the set of fuzzy attributes, and a set of edges representing the relationships among the plurality of accounts and the set of fuzzy attributes, wherein each edge in the set of edges connects a first vertex in the first set of vertex to a second vertex in the second set of vertices based on an association between a first account represented by the first vertex and a first fuzzy attribute represented by the second vertex.

7. The system of claim 1, wherein the operations further comprise:
receiving a transaction request associated with the particular account, wherein the action comprises authorizing, requesting additional data, or denying the transaction request based on the risk score.

8. A method comprising:
receiving, by a computer system, a transaction request associated with a particular account from a plurality of accounts;
accessing, by the computer system, a graph representing relationships among the plurality of accounts and a set of fuzzy attributes;
identifying, by the computer system, one or more communities of fuzzy attributes from the set of fuzzy attributes based on the graph;
generating, using a graph neural network, embeddings associated with the particular account based on the graph;
determining, by the computer system, a risk score for the particular account based on the embeddings and the one or more communities of fuzzy attributes; and
processing, by the computer system, the transaction request based on the risk score.

9. The method of claim 8, further comprising:
determining that the particular account is associated with a particular community of fuzzy attributes from the one or more communities of fuzzy attributes, wherein the risk score is determined further based on characteristics associated with the particular community of fuzzy attributes.

10. The method of claim 9, wherein the characteristics associated with the particular community of fuzzy attributes represent a distribution of different types of accounts associated with the particular community of fuzzy attributes.

11. The method of claim 10, wherein the different types of accounts comprise at least one of a first account type associated with a bad index or a second account type associated with a good index.

12. The method of claim 9, wherein the characteristics associated with the particular community of fuzzy attributes represent a distribution of different types of transactions associated with the particular community of fuzzy attributes.

13. The method of claim 8, further comprising:
generating a modified graph based on the graph, wherein the modified graph represents attribute relationships among the set of fuzzy attributes based on common associated accounts, wherein the identifying the one or more communities of fuzzy attributes is further based on the modified graph.

14. The method of claim 8, wherein the plurality of accounts is associated with a set of attributes, and wherein the operations further comprise:
deriving the set of fuzzy attributes from the set of attributes based on the account data, wherein each fuzzy attribute in the set of fuzzy attributes represents an abstraction of a corresponding attribute in the set of attributes.

15. A non-transitory machine-readable medium having stored therein machine-readable instructions executable to cause a machine to perform operations comprising:
accessing account data associated with a plurality of accounts;
generating a set of fuzzy attributes based on one or more attributes associated with each account in the plurality of accounts;
generating a graph based on the account data, wherein the graph represents relationships among the plurality of accounts and the set of fuzzy attributes;
identifying one or more communities of fuzzy attributes from the set of fuzzy attributes based on the graph;
generating, using a graph neural network, embeddings associated with the particular account based on the graph;
determining, using a machine learning model, a risk score for the particular account based on the embeddings and the one or more communities of fuzzy attributes; and
performing an action associated with the particular account based on the risk score.

16. The non-transitory machine-readable medium of claim 15, wherein the operations further comprise:
determining, using the machine learning model, an initial risk score associated with the particular account based on the embeddings, wherein the risk score is determined further based on the initial risk score.

17. The non-transitory machine-readable medium of claim 16, wherein the determining the initial risk score associated with the particular account is further based on the corresponding one or more attributes associated with the particular account.

18. The non-transitory machine-readable medium of claim 16, wherein the determining the risk score comprises modifying the initial risk score based on characteristics associated with at least one of the one or more communities.

19. The non-transitory machine-readable medium of claim 18, wherein the characteristics associated with the at least one of the one or more communities of fuzzy attributes represent a distribution of different types of transactions associated with the at least one of the one or more communities of fuzzy attributes.

20. The non-transitory machine-readable medium of claim 15, wherein the operations further comprise:
receiving a transaction request associated with the particular account, wherein the action comprises authorizing, requesting additional data, or denying the transaction request based on the risk score.
